(19) United States
(12) Patent Application Publication
(10) Pub. No.: US 2024/0202534 A1
(43) Pub. Date: Jun. 20, 2024

(54) AUTONOMOUS CHAT MESSAGE CORRECTION, PRIORITIZATION, AND REDUCTION

(71) Applicant: Raytheon Company, Waltham, MA (US)

(72) Inventors: Paul C. Hershey, Ashburn, VA (US); Mu-Cheng Wang, Acton, MA (US); Jennifer N. Coston, Ashburn, VA (US); Jennifer L. Ryan, Ashburn, VA (US); Brian D. Scarpiniti, Lower Burrell, PA (US); Darin G. Kabalkin, Ashburn, VA (US); Christopher R. Horner, Fairfax, VA (US)

(21) Appl. No.: 18/066,101

(22) Filed: Dec. 14, 2022

(51) Int. Cl. G06N 3/09; G06N 3/092

(52) U.S. Cl. CPC G06N 3/09; G06N 3/092

(57) ABSTRACT

A method includes obtaining, using at least one processing device, chat messages being sent to at least one user. The method also includes applying, using the at least one processing device, at least one machine learning model to (i) correct one or more corruptions or deviations contained in at least one of the chat messages and (ii) prioritize the chat messages. The method further includes initiating, using the at least one processing device, display of the prioritized chat messages to the at least one user in a graphical user interface. The at least one machine learning model may include (i) a first machine learning model trained to correct the one or more corruptions or deviations and (ii) a second machine learning model trained to prioritize the chat messages. The first machine learning model may be trained using supervised learning. The second machine learning model may be trained using reinforcement learning.

### GOVERNMENT RIGHTS

This invention was made with government support under contract number FA8002-21-F-02027 awarded by the United States government. The government has certain rights in the invention.

### TECHNICAL FIELD

This disclosure is generally directed to machine learning and communication systems. More specifically, this disclosure is directed to autonomous chat message correction, prioritization, and reduction.

### BACKGROUND

Users engaging in various activities often need to interact with other users or other personnel through online chat conversations. One problem that users can face is how to accurately and dynamically reduce and prioritize their ever-expanding collections of chat messages in order to focus more closely on those chat messages that are relevant or more important to the users' tasks. For example, users in a command and control center for first-responders may engage in numerous chat sessions with supervisors and other personnel in the field or in other locations, such as during a natural disaster or other incident. The number of chat messages that each user receives and reviews can expand very quickly as the number of people involved increases and as the number of domains (such as land, sea, and air operations) involved increases. In these or other situations, it may be relatively easy for individual users to be overwhelmed and miss information that is highly relevant to those users' tasks.

### SUMMARY

This disclosure relates to autonomous chat message correction, prioritization, and reduction.

In a first embodiment, a method includes obtaining, using at least one processing device, chat messages being sent to at least one user. The method also includes applying, using the at least one processing device, at least one machine learning model to (i) correct one or more corruptions or deviations contained in at least one of the chat messages and (ii) prioritize the chat messages. The method further includes initiating, using the at least one processing device, display of the prioritized chat messages to the at least one user in a graphical user interface.

In a second embodiment, an apparatus includes at least one processing device configured to obtain chat messages being sent to at least one user. The at least one processing device is also configured to apply at least one machine learning model to (i) correct one or more corruptions or deviations contained in at least one of the chat messages and (ii) prioritize the chat messages. The at least one processing device is further configured to initiate display of the prioritized chat messages to the at least one user in a graphical user interface.

In a third embodiment, a non-transitory computer readable medium contains instructions that when executed cause at least one processor to obtain chat messages being sent to at least one user. The non-transitory computer readable medium also contains instructions that when executed cause the at least one processor to apply at least one machine learning model to (i) correct one or more corruptions or deviations contained in at least one of the chat messages and (ii) prioritize the chat messages. The non-transitory computer readable medium further contains instructions that when executed cause the at least one processor to initiate display of the prioritized chat messages to the at least one user in a graphical user interface.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting autonomous chat message correction, prioritization, and reduction according to this disclosure;

FIG. 2 illustrates an example device supporting autonomous chat message correction, prioritization, and reduction according to this disclosure;

FIG. 3 illustrates an example process supporting autonomous chat message correction, prioritization, and reduction according to this disclosure;

FIG. 4 illustrates an example technique supporting chat message correction according to this disclosure;

FIGS. 5 through 8 illustrate example techniques supporting chat message prioritization and reduction according to this disclosure;

FIGS. 9A and 9B illustrate an example graphical user interface for presenting chat messages according to this disclosure; and

FIG. 10 illustrates an example method for autonomous chat message correction, prioritization, and reduction according to this disclosure.

### DETAILED DESCRIPTION

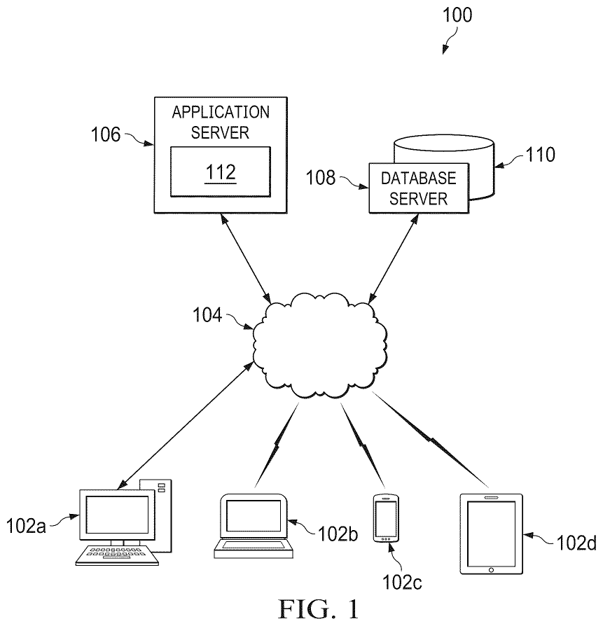

FIGS. 1 through 10, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, users engaging in various activities often need to interact with other users or other personnel through online chat conversations. One problem that users can face is how to accurately and dynamically reduce and prioritize their ever-expanding collections of chat messages in order to focus more closely on those chat messages that are relevant or more important to the users' tasks. For example, users in a command and control center for first-responders may engage in numerous chat sessions with supervisors and other personnel in the field or in other locations, such as during a natural disaster or other incident. The number of chat messages that each user receives and reviews can expand very quickly as the number of people involved increases and as the number of domains (such as land, sea, and air operations) involved increases. In these or other situations, it may be relatively easy for individual users to be overwhelmed and miss information that is highly relevant to those users' tasks.

While some approaches attempt to group and prioritize chat messages using keywords contained in the chat messages, these approaches can suffer from a number of shortcomings. For example, keywords may often be misspelled, and these approaches may not properly group or prioritize one or more chat messages if a specific keyword or keywords are misspelled or if there are other message corruptions or deviations. As a related issue, potential users often work in fields that have their own specialized words, phrases, and acronyms, which can create problems when these approaches attempt to identify keywords. Also, these approaches do not allow for dynamic prioritization as conditions change or for message prioritization to support real-time performance of tasks. Further, these approaches do not support chat message prioritization and reduction based on intents and objectives associated with the users who are receiving the chat messages. In addition, these approaches often use a single metric or a limited number of metrics in correlating related chat messages, which can limit the effectiveness of these approaches.

This disclosure provides various techniques for autonomous chat message correction, prioritization, and reduction. As described in more detail below, a first machine learning model can be trained and used to provide correction of spelling errors, syntax errors, and other corruptions or deviations in contents of chat messages. In some embodiments, the first machine learning model can be trained using a supervised learning technique. Also, a second machine learning model can be trained and used to autonomously prioritize chat messages and reduce the quantities of chat messages provided to users, such as by merging or deprioritizing chat messages. This allows the second machine learning model to collect chat messages from different sources and to prioritize and reduce the chat messages. In some cases, the prioritization or reduction can be based on various factors, such as when based on the intents and objectives associated with the users who are receiving the chat messages. In some embodiments, the second machine learning model can be trained using a reinforcement learning technique. In some embodiments, a graphical user interface can be used to present chat messages to users based on the results obtained using the first and second machine learning models. For instance, the graphical user interface can adjust the display of chat messages, such as by displaying the chat messages in priority order or with priority-based indicators. In some instances, the chat messages can be displayed based on geolocations and other user-related intents or objectives.

In this way, the first machine learning model used here can be trained to support the correction of errors and other corruptions or deviations of words in chat messages. As a related matter, the first machine learning model used here can be trained to support these functions for specialized words, phrases, and acronyms used in a specific application. This can allow the described techniques to more effectively process chat messages even in the presence of corruptions/deviations and even when chat messages are associated with uncommon language formats. Also, the second machine learning model used here can be trained to effectively prioritize and reduce the number of chat messages provided to users. Effective training, optionally coupled with feedback (such as during reinforcement learning), can help to provide increased levels of confidence in the message prioritization and reduction. Moreover, the described techniques can allow for dynamic prioritization of chat messages as conditions change and enable message prioritization to support real-time performance of tasks. Further, the described techniques support chat message prioritization and reduction based on the intents and objectives associated with the users who are receiving the chat messages, which can help to ensure that the chat messages are prioritized and reduced in appropriate manners for the users. In addition, the described techniques can support the use of large numbers of metrics when determining how related chat messages are correlated, which can increase the effectiveness of these techniques.

Note that the techniques presented in this disclosure are often described with reference to systems used by first-responders and warfighters. For example, the described techniques may be used by users to support real-time emergency responses by first-responders or tactical engagements in complex multi-domain environments by warfighters. As a particular example, during emergency responses by first-responders, command and control personnel may often have dozens of simultaneous chat conversations. As another particular example, during military operations, drone or other operators may often have dozens of simultaneous chat conversations occurring for a single domain. With the expansion of battle spaces to include multi-mission scenarios (where operators are involved in two or more missions at the same time) and multi-domain scenarios (where operations are occurring in multiple domains like land, air, sea, space, and cyberspace environments), the number of simultaneous chat sessions can increase to even larger numbers. In either use case, the described techniques may be used to reduce the number of displays that operators need to use by prioritizing and reducing the number of chat messages presented. In some cases, the described techniques can be used to support chat communications (possibly multi-domain chat conversations) on a single display, which is often referred to as a “single pane of glass.” Note, however, that the described techniques may be used with any other suitable devices or systems for any other suitable use cases or applications.

FIG. 1 illustrates an example system 100 supporting autonomous chat message correction, prioritization, and reduction according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information. At least some of the user devices 102a-102d can be configured to enable chat communications to occur between users.

The network 104 facilitates communication between various components of the system 100, such as via wired or wireless connections. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the execution of one or more applications 112, at least one of which is designed to correct, prioritize, and reduce chat messages communicated to or from one or more of the user devices 102a-102d. For example, the application 112 may be configured to receive chat messages being sent to, from, or between the user devices 102a-102d. The application 112 may also apply a first machine learning model to provide correction of spelling errors, syntax errors, and other corruptions or deviations in contents of the chat messages. The application 112 may further apply a second machine learning model to prioritize the chat messages and reduce the quantities of chat messages provided to the user devices 102a-102d.

The database server 108 operates to store and facilitate retrieval of various information used, generated, or collected by the application server 106 and the user devices 102a-102d in the database 110. For example, the database server 108 may store various information in relational database tables or other data structures in the database 110. In some embodiments, the database 110 can be used to store and facilitate retrieval of chat messages or information regarding how the chat messages are prioritized, reduced, or otherwise processed by the application server 106. Note that the database server 108 may also be used within the application server 106 to store information, in which case the application server 106 may store the information itself.

Although FIG. 1 illustrates one example of a system 100 supporting autonomous chat message correction, prioritization, and reduction, various changes may be made to FIG. 1. For example, the system 100 may include any suitable number of user devices 102a-102d, networks 104, application servers 106, database servers 108, and databases 110. Also, these components may be located in any suitable locations and might be distributed over a large area. Further, functionalities described as being performed using one or more components in FIG. 1 may be performed by one or more other components in FIG. 1. For instance, the user devices 102a-102d may incorporate functionalities of the application server 106 and the database server 108 that implement chat message correction, prioritization, and reduction described in this patent document. In addition, while FIG. 1 illustrates one example operational environment in which autonomous chat message correction, prioritization, and reduction may be used, this functionality may be used in any other suitable system.

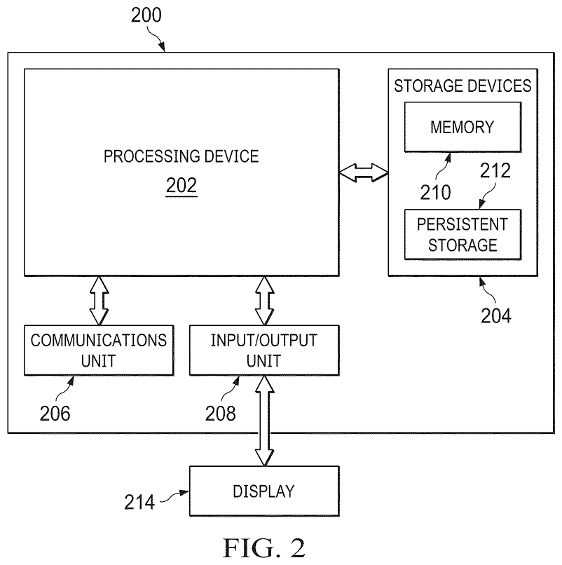

FIG. 2 illustrates an example device 200 supporting autonomous chat message correction, prioritization, and reduction according to this disclosure. One or more instances of the device 200 may, for example, be used to at least partially implement the functionality of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display 214 or other suitable output device. Note, however, that the I/O unit 208 may be omitted if the device 200 does not require local I/O, such as when the device 200 represents a server or other device that can be accessed remotely.

In some embodiments, instructions can be executed by the processing device 202 in order to implement the functionality of the one or more applications 112. For example, the processing device 202 may execute instructions that cause the processing device 202 to obtain chat messages, apply a first machine learning model to correct corruptions or deviations in contents of the chat messages, and apply a second machine learning model to prioritize and optionally reduce the chat messages provided to or displayed by one or more user devices 102a-102d.

Although FIG. 2 illustrates one example of a device 200 supporting autonomous chat message correction, prioritization, and reduction, various changes may be made to FIG. 2. For example, computing and communication devices and systems come in a wide variety of configurations, and FIG. 2 does not limit this disclosure to any particular computing or communication device or system.

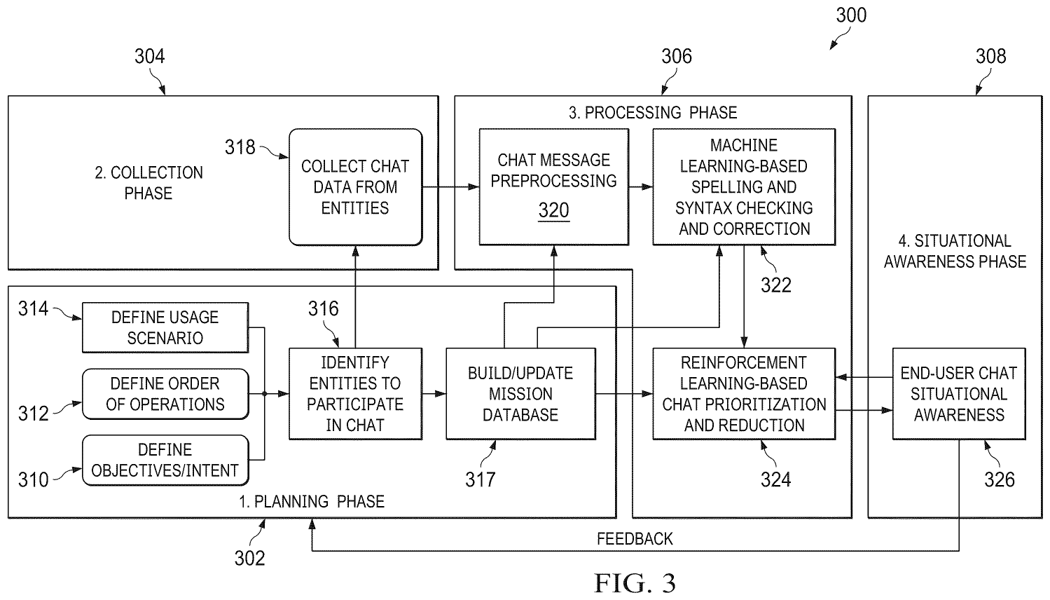

FIG. 3 illustrates an example process 300 supporting autonomous chat message correction, prioritization, and reduction according to this disclosure. For instance, the process 300 shown in FIG. 3 may involve the use of the application server 106 or other component(s) in the system 100 of FIG. 1 to correct, prioritize, and reduce chat messages sent to, from, or between the user devices 102a-102d. In some cases, the application server 106 or other component(s) involved in the process 300 may be implemented using one or more instances of the device 200. However, some or all of the process 300 may be performed using any other suitable device(s) and in any other suitable system(s).

As shown in FIG. 3, the process 300 is generally divided into four stages or phases, namely a planning phase 302, a collection phase 304, a processing phase 306, and a situational awareness phase 308. The planning phase 302 is generally associated with an identification of the entities (such as users or user roles, groups of users or user roles, or organizations) that may engage in chat communications, such as with one another. The planning phase 302 is also generally associated with the collection of information associated with the environment in which those entities may engage in chat communications.

In this example, the planning phase 302 includes an identification function 310 that relates to identifying one or more objectives and at least one intent associated with a specified environment in which various entities may engage in chat communications. The objective(s) and intent(s) identified here can vary based on the application in which the system 100 is being used. For example, when used in a first-responder setting, the objective(s) may include performance of law enforcement, emergency medical, or firefighting operations, where possible intents may include minimizing causalities or expediting evacuations. When used in a warfighting setting, the objective(s) may include one or more tactical or strategic objectives, where possible intents may include one or more goals associated with warfighting actions. Note that the objective(s) and intent(s) can be identified here in any suitable manner, such as manually or in an automated manner.

The planning phase 302 also includes an identification function 312 that identifies at least one order of operations associated with the specified environment in which various entities may engage in chat communications. Again, the at least one order of operations identified here can vary based on the application in which the system 100 is being used. For example, when used in a first-responder setting, the at least one order of operations may define actions to be taken in response to certain events like a natural disaster or other incident. An example order of operations may define actions such as establishing a perimeter, evacuating civilians/bystanders/other people, and initiating various law enforcement/emergency medical/firefighting actions. When used in a warfighting setting, the at least one order of operations may define actions to be taken during warfighting actions, such as when the at least one order of operations defines an order of battle. Note that the at least one order of operations can be identified here in any suitable manner, such as manually or in an automated manner.

The planning phase 302 further includes an identification function 314 that identifies at least one usage scenario associated with various entities that may engage in chat communications. Again, the at least one usage scenario identified here can vary based on the application in which the system 100 is being used. For example, when used in a first-responder setting, the at least one usage scenario may indicate that chat communications will occur in the context of law enforcement, emergency medical, or firefighting operations. When used in a warfighting setting, the at least one usage scenario may indicate that chat communications will occur in the context of military operations, such as drone operations, special operations involving warfighters, or other military operations. Note that the at least one usage scenario can be identified here in any suitable manner, such as manually or in an automated manner.

The objective(s), intent(s), order(s) of operations, and usage scenario(s) are collectively used during an identification function 316 to identify specific entities that may engage in chat communications in the specified environment. The specific entities that are identified here may be identified as individuals, based on their user roles, or in any other suitable manner. For example, when used in a first-responder setting, the specific entities may include personnel or personnel roles in a command and control center, 911 or other emergency operators, and law enforcement/emergency medical/firefighting onsite commanders or other onsite personnel. When used in a warfighting setting, the specific entities may include personnel or personnel roles in a military command and control center, pilots in a drone operations centers, commanders or other personnel on the ground, or other personnel. Note that the specific entities can be identified here in any suitable manner, such as manually or in an automated manner. Also note that, in some cases, one or more of the identified entities may represent vehicles, platforms, sensors, or other electronic components that can send data (such as collected sensor data) to one or more users in the form of chat messages or alerts.

The identified entities (possibly along with other information) are provided to a mission database build/update function 317, which can be used to build a database of words, phrases, chat message syntax, or other message contents that are likely to be used in a given use case. Depending on the implementation, the database may be populated manually or automatically, such as via one or more known good training datasets. The database can also be updated as needed or desired, such as when additional data becomes available. The additional data may, for instance, represent feedback from users of words, phrases, chat message syntax, or other message contents that are actually being encountered in the use case. The additional data may also or alternatively come from updated intents or objectives, updated orders of operations, or updated usage scenarios.

The identified entities are used to perform a data collection operation 318 in the collection phase 304. The data collection operation 318 generally operates to collect chat messages that are sent to, from, or between the identified entities. For example, the data collection operation 318 can be used to collect chat messages that are sent during a natural disaster or other incident, during warfighting operations, or at other times. The information provided by the identification function 316 can be used to control or instruct the data collection operation 318, such as by identifying which sensors can participate the chat message exchange or collection. The chat messages may be obtained here in any suitable manner. For instance, in some cases, the data collection operation 318 may be performed on the application server 106, and the application server 106 may also be responsible for transmitting chat messages to, from, or between the user devices 102a-102d. In other cases, the data collection operation 318 may be performed on the user devices 102a-102d themselves.

The obtained chat messages are provided to a pre-processing function 320 in the processing phase 306. The pre-processing function 320 generally operates to pre-process the obtained chat messages in order to prepare the chat messages for further processing using one or more machine learning models. For example, the pre-processing function 320 can process the chat messages in order to tokenize the chat messages and tag different portions of the chat messages. Tokenizing the chat messages can be done in order to segment the chat messages into different types of segments, such as words and punctuations marks, and may be based on keywords and syntax information from the identification function 316 or the mission database build/update function 317. Tagging the different portions in the chat messages can be done in order to identify different parts-of-speech in the chat messages. Note, however, that the pre-processing function 320 may perform any other or additional processing operations involving the chat messages. The pre-processing function 320 may include any suitable logic for pre-processing chat messages. In some embodiments, the pre-processing function 320 may implement at least a portion of the “spaCy” natural language processing pipeline.

The pre-processed chat messages are provided to a first machine learning model 322, which processes at least some of the chat messages in order to correct for corruptions or deviations in contents of the chat messages. For example, the first machine learning model 322 can be trained to identify misspelled words in chat messages and to automatically correct those words in the chat messages. The first machine learning model 322 can also be trained to identify syntax errors in chat messages and to automatically correct those syntax errors in the chat messages. In some cases, the first machine learning model 322 can be trained as part of the planning phase 302 and deployed for use during the processing phase 306. As described below, the first machine learning model 322 may optionally support the use of parallel processing pipelines or processing paths in order to support the use of different types of spelling and syntax corrections in the chat messages. As a particular example, the first machine learning model 322 may support a first processing pipeline or processing path used to provide spelling and syntax corrections in a first subset of chat messages based on the language(s) being used by the users, which generally tends to include unstructured language contents. The first machine learning model 322 may also support a second processing pipeline or processing path used to provide spelling and syntax corrections in a second subset of chat messages that have more structured contents. In either case, the first machine learning model 322 can provide spelling and syntax corrections for specialized words, phrases, acronyms, or other text contained in chat messages involving the users.

The first machine learning model 322 represents any suitable machine learning model that has been trained to identify and correct spelling errors, syntax errors, or other corruptions or deviations contained in chat messages. The first machine learning model 322 may use any suitable machine learning-based architecture to support the described functions. For example, the first machine learning model 322 may be implemented as a convolutional neural network, recurrent neural network, deep neural network, or other neural network or other machine learning model architecture. In some cases, the first machine learning model 322 can be trained using supervised learning, which may involve using labeled or unlabeled training data to train the first machine learning model 322. For instance, the first machine learning model 322 can be provided training data in the form of chat messages, and weights or other parameters of the first machine learning model 322 can be modified until the first machine learning model 322 properly corrects known correct spelling errors, syntax errors, or other corruptions or deviations contained in those chat messages.

Among other things, the first machine learning model 322 can be trained to correct for corruptions or deviations in chat message contents across a wide range of possible message contents. This allows the first machine learning model 322 to extend beyond simply recognizing regular expressions and to correct for corruptions or deviations over a much wider range of chat message contents, including chat messages in uncommon language formats. Moreover, the abilities of the first machine learning model 322 can be expanded over time by retraining the first machine learning model 322 using larger sets of training data (or by replacing the first machine learning model 322 with a new machine learning model trained using the larger sets of training data). Further, the training data can include suitable datasets to help provide the desired functionality of the first machine learning model 322, such as by including training datasets directed to specific areas of interest, targets, or tasks. This approach can help to reduce or avoid situations where, for instance, a regular expressions library needs to be constantly updated to account for typographical/grammatical errors, new data formats, or additional target data (which tend to require time-consuming library updates and reduces the ability to quickly adapt to user needs). This is because the first machine learning model 322 provides desired error correction, so regular expression algorithms do not need to be updated (since only correct keywords are processed via regular expressions). In addition, database updates can be done manually or automatically, such as via one or more known good training datasets (which again can be done off-line).

The chat messages (including the corrected chat messages) and the database produced by the mission database build/update function 317 are provided to a second machine or reinforcement learning model 324, which generally operates to prioritize and (if possible) reduce the number of chat messages provided to the identified entities. For example, the second machine learning model 324 can be trained to identify chat messages that are more relevant or more important to particular tasks being performed by the users and to increase the priorities of those chat messages. Similarly, the second machine learning model 324 can be trained to identify chat messages that are less relevant or less important to the particular tasks being performed by the users and to decrease the priorities of those chat messages. The second machine learning model 324 here can (among other things) use the identified objective(s) and intent(s) when determining which chat messages should have increased or decreased priorities. The second machine learning model 324 can further combine chat messages and generate proposed actions to support the performance of tasks by the users, such as by combining multiple higher-priority or lower-priority chat messages into a single chat message group for display and recommending one or more actions involving the chat message group. As a particular example, the second machine learning model 324 can autonomously prioritize and reduce the quantity of chat messages, such as by prioritizing chat messages to only those that are relevant to the objective(s) and intent(s) related to specific users.

The second machine learning model 324 represents any suitable machine learning model that has been trained to prioritize and optionally combine chat messages. The second machine learning model 324 may use any suitable machine learning-based architecture to support the described functions. For example, the second machine learning model 324 may be implemented as a convolutional neural network, recurrent neural network, deep neural network, or other neural network or other machine learning model architecture. In some cases, the second machine learning model 324 can be trained using reinforcement learning, which may involve using feedback and a reward system to train the second machine learning model 324 how to properly prioritize and optionally combine chat messages and generate actions for the chat messages. Note that, in some cases, the second machine learning model 324 can process chat messages after the first machine learning model 322 has corrected the corruptions or deviations in the chat messages, which can help to prioritize time and processing resources when analyzing the chat messages.

Among other things, the second machine learning model 324 can be trained to effectively prioritize and optionally combine chat messages, which can help to increase confidence levels in message prioritization and reduction. For example, users can gain confidence that the second machine learning model 324 does not lose or deprioritize key chat messages because of its autonomy. Also, the second machine learning model 324 may optionally be used to automatically generate actions to be taken by users based on the chat messages, which can help to support performance of various operations by the users. Using feedback (such as from at least one end-user application 326), the reinforcement machine learning model 324 can dynamically adjust its action generation process. For instance, if an action cannot be executed or received by an end user in time, the reinforcement machine learning model 324 may adjust its priority. In some cases, the feedback from the at least one end-user application 326 to the planning phase 302 can represent feedback from the present mission that can influence chat planning of one or more subsequent missions, such as feedback indicating that some chat participants in the present mission should not be included in chat sessions for the subsequent mission(s). In addition, the second machine learning model 324 may support confidentiality of information, such as when the second machine learning model 324 is trained to enforce government information classifications or other security levels.

The chat messages (as prioritized and reduced by the second machine learning model 324) are provided to one or more instances of an end-user application 326, which is used to provide user situational awareness (SA). For example, the end-user application 326 may include or support a graphical user interface (GUI) that can, among other things, present chat messages in priority order to one or more users. In some cases, the graphical user interface may present a map or other graphical representation of a geographic area in which one or more operations associated with the user(s) are occurring. In these cases, the end-user application 326 may adjust display of the chat messages according to geolocation and other objectives, such as when the end-user application 326 displays chat messages associated with the displayed geographic area higher than chat messages associated with other geographic areas. In some embodiments, the end-user application 326 may be implemented as described in U.S. patent application Ser. No. 17/508,450 (which is hereby incorporated by reference in its entirety).

It should be noted that the functions shown in or described with respect to FIG. 3 can be implemented in at least one application server 106, end-user device 102a-102d, device 200, or other device(s) in any suitable manner. For example, in some embodiments, at least some of the functions shown in or described with respect to FIG. 3 can be implemented or supported using one or more software applications or other software instructions that are executed by one or more processing devices 202. In other embodiments, at least some of the functions shown in or described with respect to FIG. 3 can be implemented or supported using dedicated hardware components. In general, the functions shown in or described with respect to FIG. 3 can be performed using any suitable hardware or any suitable combination of hardware and software/firmware instructions. Also, the functions shown in or described with respect to FIG. 3 can be performed using a single device or any suitable combination of devices.

Although FIG. 3 illustrates one example of a process 300 supporting autonomous chat message correction, prioritization, and reduction, various changes may be made to FIG. 3. For example, any other suitable technique may be used to identify the entities for whom chat message correction, prioritization, and reduction are performed. Also, while shown as using separate machine learning models 322 and 324, the machine learning models 322 and 324 may represent portions of a common machine learning model that has been trained to perform chat message correction, prioritization, and reduction. In addition, chat messages that have been corrected, prioritized, and reduced may be used in any other suitable manner.

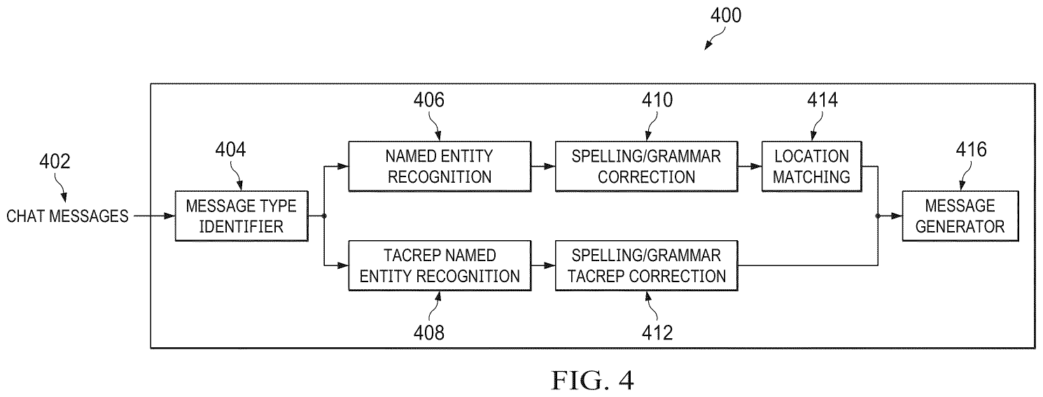

FIG. 4 illustrates an example technique 400 supporting chat message correction according to this disclosure. The technique 400 shown in FIG. 4 may, for example, be implemented by the machine learning model 322 in the process 300 shown in FIG. 3. As shown in FIG. 4, the technique 400 is generally used to receive and process chat messages 402, which may represent chat messages as pre-processed by the pre-processing function 320. The chat messages 402 are provided to a message type identifier function 404, which generally operates to analyze each chat message 402 and determine a message type associated with each chat message 402. For example, as noted above, the chat messages 402 may include (i) chat messages containing unstructured language contents and (ii) chat messages containing structured contents. The chat messages containing unstructured language contents may represent free-form chat messages drafted by users using normal everyday English or another language. The chat messages containing structured contents may represent chat messages drafted by users using specific formatting and content rules, such as certain types of chat messages drafted by military personnel or other personnel. In this example, the message type identifier function 404 can determine whether each chat message 402 is a normal-language chat message (unstructured) or a tactical report (TACREP) chat message (a type of structured chat message). In some cases, this can be determined based on whether each chat message 402 includes “Tactical Report,” “TACREP,” or some variation of these spellings at or near a beginning of the chat message 402.

In this example, unstructured chat messages 402 are processed using a first pipeline shown along the top of FIG. 4, and structured chat messages 402 are processed using a second pipeline shown along the bottom of FIG. 4. The first pipeline here includes a named entity recognition function 406, and the second pipeline here includes a TACREP named entity recognition function 408. Each named entity recognition function 406 and 408 generally operates to identify specific named entities, such as people, places, or organizations, within the chat messages 402. Each named entity recognition function 406 and 408 also generally operates to classify the named entities, such as by classifying each of the identified named entities as a person, place, or organization. In some cases, the named entity recognition function 406 may identify named entities anywhere within the chat messages 402 (since those are unstructured), while the TACREP named entity recognition function 408 may identify named entities in one or more specific locations within the chat messages 402 (since those are structured). However, this is not necessarily required.

The unstructured chat messages 402 are provided to a spelling/grammar correction function 410, which generally operates to correct spelling errors, syntax errors, or other corruptions or deviations contained in the unstructured chat messages 402. In some cases, the spelling/grammar correction function 410 can use rules or other logic based on the specific language(s) contained in the unstructured chat messages 402. Similarly, the structured chat messages 402 are provided to a spelling/grammar TACREP correction function 412, which generally operates to correct spelling errors, syntax errors, or other corruptions or deviations contained in the structured chat messages 402. In some cases, the spelling/grammar TACREP correction function 412 can use rules or other logic based on the expected structure and contents of the structured chat messages 402. As a particular example, some TACREP chat messages may be expected to have the following format.

<Callsign> / TACREP I-<ID> / <BE#> / <Brevity> / <Activity> / <Bullseye> <Bearing> /
<Range> / <Link 16 Track ID> / <Coordinate> / <Time of Collection>

The spelling/grammar TACREP correction function 412 may assume this format is being used in order to determine how contents in each field might be corrected. In some cases, one or more of the fields may be ignored for spelling/grammar checking purposes, such as callsigns and identifiers. This is because callsign names and message identifiers may not follow standard spelling/grammar rules.

In some embodiments, one or both of the spelling/grammar correction function 410 and the spelling/grammar TACREP correction function 412 may use a database in order to help detect or correct typographical or syntax errors in the chat messages 402. In some cases, the database may include one or more dictionaries tailored to one or more specific applications of the system 100, such as when at least one dictionary is tailored to expected message contents from specific users or types of users. Also, in some instances, new dictionaries and syntax rules can be added to the dictionary, such as via one or more known good training datasets used to train the first machine learning model 322.

A location matching function 414 may optionally be used with the unstructured chat messages 402. The location matching function 414 may generally operate to use the contents of the unstructured chat messages 402 in order to identify geolocations associated with the unstructured chat messages 402. For example, in some cases, an unstructured chat message 402 may include latitude/longitude or other coordinates, a named location, or other contents that can be used to identify a geolocation associated with the unstructured chat message 402. This may be useful, for instance, when chat messages 402 associated with a specific geographic area (such as one displayed in a map of a graphical user interface) are prioritized above chat messages 402 associated with other geographic areas. Note that the structured chat messages 402 may not need location matching since the structured chat messages 402 may be assumed to include geolocations as part of their message contents.

A message generation function 416 may optionally process the structured and unstructured chat messages 402 and information about the structured and unstructured chat messages 402 in order to produce chat messages having a uniform or specified format. For example, the message generation function 416 may arrange tokens within the chat messages 402 so that the tokens have a standardized or expected arrangement. As a particular example, the message generation function 416 may arrange tokens within the chat messages 402 in accordance with the Universal Command and Control Interface (UCI) message format. The chat messages produced by the message generation function 416 may be provided to end users, such as via one or more end-user applications 326 executed on one or more user devices 102a-102d. Note, however, that any other suitable formats may be supported by the message generation function 416. Also note that the message generation function 416 may be omitted if there is no need to have chat messages with a unified or specified format.

The first machine learning model 322 can be trained to perform the technique 400 shown here in any suitable manner. For example, in some cases, one or more labeled training datasets can be used to adjust weights or other parameters of the first machine learning model 322. Here, training data representing chat messages containing known spelling errors, syntax errors, and other corruptions or deviations can be provided to the first machine learning model 322. The first machine learning model 322 can extract features of the training data and process the features to determine how the corruptions or deviations should be corrected. The predicted corrections produced by the first machine learning model 322 can be compared to the training data labels (known as “ground truths”), and differences or errors between the predictions and the ground truths can be identified and used to calculate an overall error or loss for the first machine learning model 322. Any suitable loss function may be used here to calculate the loss. If the calculated loss exceeds a threshold, weights or other parameters of the first machine learning model 322 can be adjusted, and training data (either the same training data or new training data) can be processed again using the updated first machine learning model 322 in order to produce new predictions that can be compared to ground truths in order to calculate an updated loss.

Ideally, the calculated loss decreases over time and eventually falls below the threshold, indicating that the first machine learning model 322 has been trained to accurately (at least to within the desired accuracy represented by the threshold) predict corrections to chat messages. If desired, validation of the first machine learning model 322 may then occur, such as when a combination of simulated and live data is provided to the trained first machine learning model 322 in order to determine whether the first machine learning model 322 as trained provides adequate results. If not, retraining of the first machine learning model 322 may occur. In some cases, the training/validation dataset or datasets that are used here can be customizable. For instance, real or simulated data can be used to create any desired number of training/validation chat messages (depending on training needs), and the training/validation chat messages can be modified or tailored for use with a specific application.

It should be noted that the functions shown in or described with respect to FIG. 4 can be implemented in at least one application server 106, end-user device 102a-102d, device 200, or other device(s) in any suitable manner. For example, in some embodiments, at least some of the functions shown in or described with respect to FIG. 4 can be implemented or supported using one or more software applications or other software instructions that are executed by one or more processing devices 202. In other embodiments, at least some of the functions shown in or described with respect to FIG. 4 can be implemented or supported using dedicated hardware components. In general, the functions shown in or described with respect to FIG. 4 can be performed using any suitable hardware or any suitable combination of hardware and software/firmware instructions. Also, the functions shown in or described with respect to FIG. 4 can be performed using a single device or any suitable combination of devices.

Although FIG. 4 illustrates one example of a technique 400 supporting chat message correction, various changes may be made to FIG. 4. For example, while two pipelines are shown here, the technique 400 may support the use of a single pipeline or more than two pipelines.

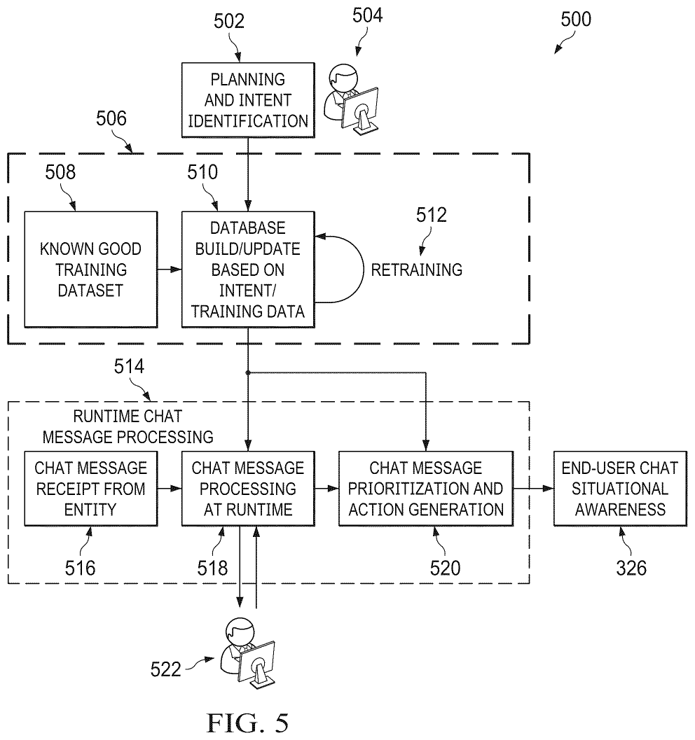

FIGS. 5 through 8 illustrate example techniques 500-800 supporting chat message prioritization and reduction according to this disclosure. The techniques 500-800 shown in FIGS. 5 through 8 may, for example, be implemented by the second machine learning model 324 in the process 300 shown in FIG. 3. As shown in FIG. 5, a planning and intent identification function 502 involving one or more users 504 (such as mission planners) may be performed. In some cases, the users 504 can manually define a commander's intents, task priority, and keywords, phrases, chat message syntax, or other message contents that are likely to be used given a specific mission. This information can be processed in a database build/update function 510. The identification function 502 may be the same as or form a part of the identification function 310, which is used to identify one or more objectives and at least one intent.

During a build/training phase 506, information from the identification function 502 and/or at least one known good training dataset 508 are used by the database build/update function 510. The database build/update function 510 may be the same as or form a part of the mission database build/update function 317. The database build/update function 510 generally operates to use this information to identify words, phrases, chat message syntax, or other message contents that are likely to be used given the specific planning and intent and optionally the training dataset(s) 508. When needed or desired, a retraining function 512 may be performed to repeat usage of the database build/update function 510 and update the database. This may occur, for instance, when one or more additional training datasets 508 or new information from the planning and intent identification function 502 becomes available.

During an inferencing phase 514, chat messages can be received and processed using the database produced during the build/training phase 506. For example, a chat message receipt function 516 can detect the receipt of a chat message, such as a chat message 402 that has been pre-processed and possibly processed using the first machine learning model 322 as described above. One example purpose of the pre-processing with the first machine learning model 322 is to help ensure that the chat messages and their associated keywords are corrected with respect to spelling, typos, etc. A processing function 518 can process the chat message in order to determine whether the chat message can be further processed for prioritization. If so, a chat message prioritization and action generation function 520 can process the chat message in order to (i) determine a prioritization of the chat message and (ii) optionally generate one or more actions to be performed by at least one user based on the chat message or its prioritization. The prioritized chat message and optionally the one or more actions can be provided to the user(s), such as via at least one end-user application 326. If the processing function 518 determines that the chat message cannot be further processed for prioritization, an error or other notification may be provided to one or more users 522, such as the user who is sending the chat message, the user who is receiving the chat message, or one of the users 504. The user(s) 522 may be permitted to provide information indicating how to resolve any issues with the chat message, such as by identifying a correction to the chat message that was not made by the first machine learning model 322.

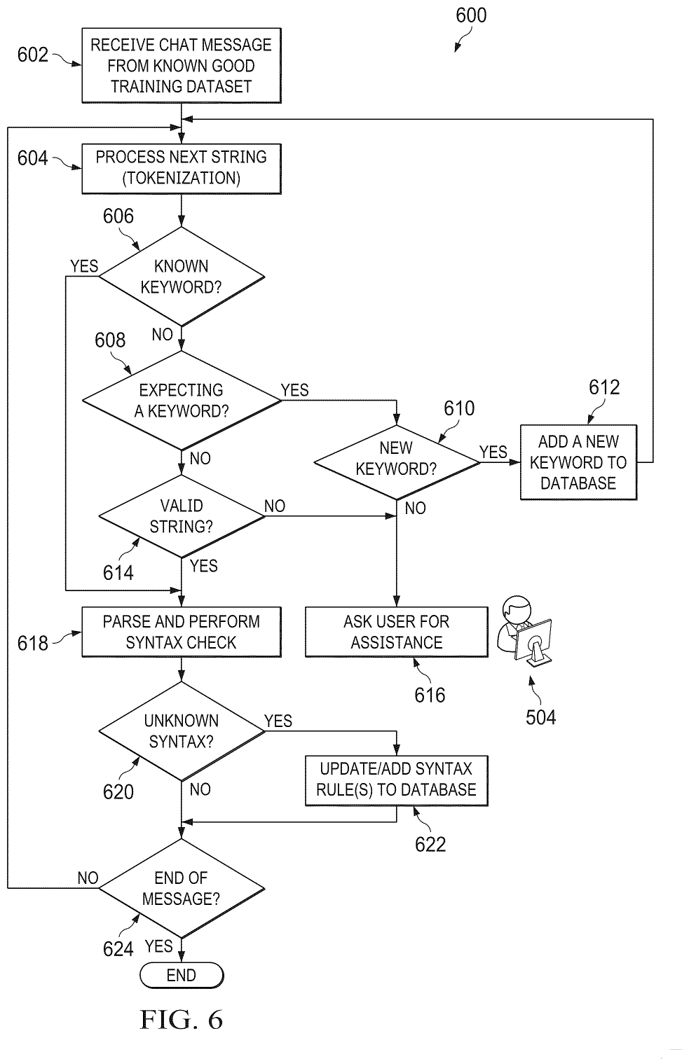

The technique 600 of FIG. 6 may represent a specific example implementation of how the database build/update function 510 may be performed during the build/training phase 506. As shown in FIG. 6, a chat message is received from a good known training dataset at step 602. This may include, for example, the processing device 202 of the application server 106 obtaining a chat message containing example contents that might be received from an actual user, where the chat message is included in the known good training dataset 508. A first portion of the chat message, such as a first string containing one or more tokens, is selected at step 604. This may include, for example, the processing device 202 of the application server 106 selecting the first token or collection of tokens in the obtained chat message.

A determination is made whether the selected portion of the chat message includes a known keyword at step 606. This may include, for example, the processing device 202 of the application server 106 comparing one or more words in the selected portion of the chat message with any words contained in a database. If no keyword is found, a determination is made whether a keyword was expected to be found at step 608. This may include, for example, the processing device 202 of the application server 106 using the expected structure of the chat message or expected rules of grammar associated with the chat message. If a keyword is expected, a determination is made whether the selected portion of the chat message includes a new keyword at step 610. This may include, for example, the processing device 202 of the application server 106 examining the word(s) contained in the selected portion of the chat message for a word that appears to be a keyword. If one is found, the new keyword is added to a database at step 612.

If a keyword is not expected at step 608, a determination is made whether at least the selected portion of the chat message contains a valid string at step 614. This may include, for example, the processing device 202 of the application server 106 determining whether the contents of at least the selected portion of the chat message have a format indicative of the chat message containing a valid string. If no valid string is detected at step 614 or no keyword is detected at step 610, at least one user is asked for assistance at step 616. This may include, for example, the processing device 202 of the application server 106 generating a notification to a user 504 asking the user 504 for assistance in understanding at least the selected portion of the chat message. The user 504 may respond by identifying a keyword or providing other input that can help the application server 106 understand and learn from the contents of the chat message being processed.

If the selected portion of the chat message contains a known keyword at step 606 or the chat message contains a valid string at step 614, parsing and a syntax check are performed at step 618. This may include, for example, the processing device 202 of the application server 106 parsing the chat message and determining whether the contents of the chat message comply with known syntax rules, such as any syntax rules stored in the database. A determination is made whether the chat message contains an unknown syntax at step 620. If so, one or more syntax rules can be added or updated in the database in order to account for the unknown syntax of the chat message at step 622. This may include, for example, the processing device 202 of the application server 106 defining one or more new syntax rules or updating one or more existing syntax rules based on the syntax of the chat message being processed. A determination is made whether the end of the chat message has been reached at step 624. If not, the process returns to step 604 to select the next portion of the chat message for processing.

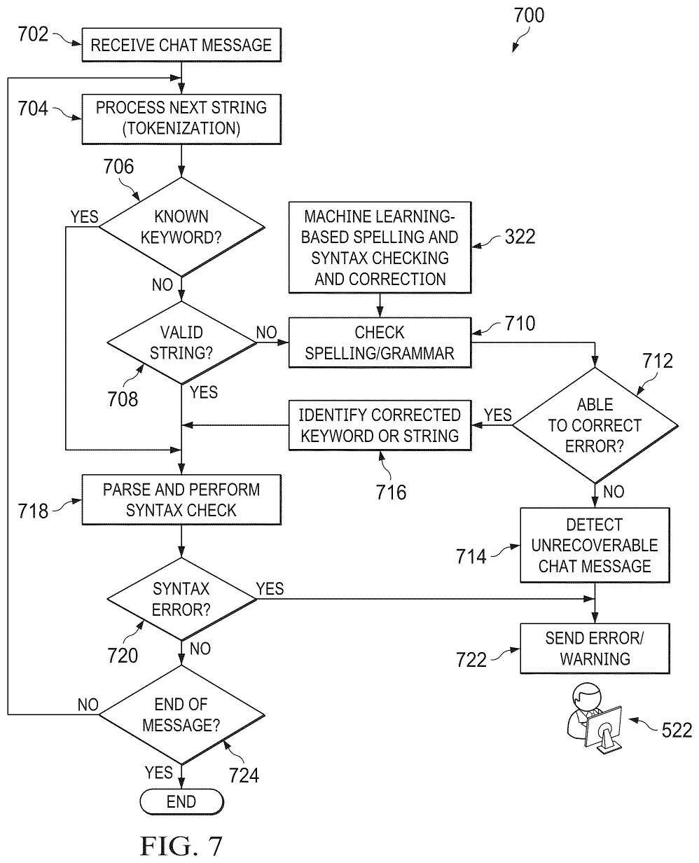

The technique 700 of FIG. 7 may represent a specific example implementation of how the processing function 518 may be performed during the inferencing phase 514. As shown in FIG. 7, a chat message is received at step 702. This may include, for example, the processing device 202 of the application server 106 obtaining a chat message being sent to, from, or between one or more of the user devices 102a-102n. A first portion of the chat message, such as a first string containing one or more tokens, is selected at step 704. This may include, for example, the processing device 202 of the application server 106 selecting the first token or collection of tokens in the obtained chat message.

A determination is made whether the selected portion of the chat message includes a known keyword at step 706. This may include, for example, the processing device 202 of the application server 106 comparing one or more words in the selected portion of the chat message with any words contained in the database (where the database can be populated as described above with respect to FIG. 6). If no keyword is found, a determination is made whether at least the selected portion of the chat message contains a valid string at step 708. This may include, for example, the processing device 202 of the application server 106 determining whether the contents of at least the selected portion of the chat message have a format indicative of the chat message containing a valid string. If no valid string is detected at step 708, a spelling and grammar correction operation occurs at step 710. This may include, for example, the processing device 202 of the application server 106 applying the first machine learning model 322 to at least the selected portion of the chat message.

A determination is made whether the spelling and grammar correction was able to correct one or more errors in the chat message at step 712. This may include, for example, the processing device 202 of the application server 106 determining whether any corrections were made in at least the selected portion of the chat message and, if so, whether one or more keywords or a valid string can now be detected in the selected portion of the chat message. If not, an unrecoverable chat message may be detected at step 714, and a warning or other notification may be sent to at least one user at step 722. This may include, for example, the processing device 202 of the application server 106 generating an error or other message indicating that the chat message cannot be analyzed. Otherwise, at least one corrected keyword or valid string can be identified at step 716.

If a known keyword is detected at step 706, a valid string is detected at step 708, or a corrected keyword or valid string is identified at step 716, parsing and a syntax check are performed at step 718. This may include, for example, the processing device 202 of the application server 106 parsing the chat message and determining whether the contents of the chat message comply with the syntax rules as defined in the database. A determination is made whether the chat message contains a syntax error at step 720. This may include, for example, the processing device 202 of the application server 106 determining whether the chat message contains syntax that violates one or more syntax rules in the database. If so, a warning or other notification may be sent to at least one user at step 722. This may include, for example, the processing device 202 of the application server 106 generating an error or other message indicating that the chat message cannot be analyzed. A determination is made whether the end of the chat message has been reached at step 724. If not, the process returns to step 704 to select the next portion of the chat message.

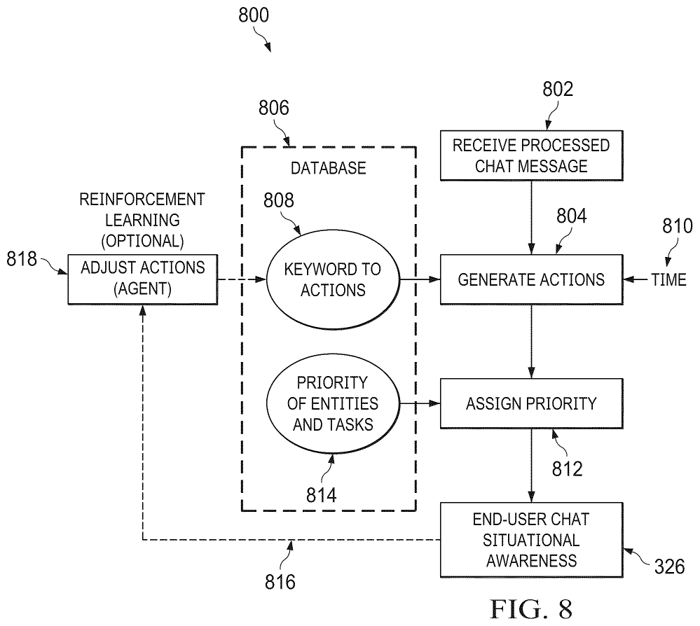

The technique 800 of FIG. 8 may represent a specific example implementation of how the chat message prioritization and action generation function 520 may be performed during the inferencing phase 514. As shown in FIG. 8, a processed chat message is received at step 802. This may include, for example, the processing device 202 of the application server 106 obtaining a chat message that has been processed as shown in FIG. 7. One or more actions corresponding to the processed chat message are generated at step 804. This may include, for example, the processing device 202 of the application server 106 accessing a database 806, which can include mappings 808 that associate keywords with actions. The database 806 may also be used to store information as described above, such as keywords and syntax rules. The keyword(s) contained in the processed chat message can be used to access the database 806 and identify one or more actions to be performed based on the keyword(s) using the mappings 808. Note that a time signal 810 may optionally be used here, which may indicate that certain actions can or cannot be performed at the current time or at one or more future times.

One or more priorities are assigned to the action(s) corresponding to the processed chat message at step 812. This may include, for example, the processing device 202 of the application server 106 accessing the database 806, which can also include mappings 814 that associate priorities associated with the entities sending/receiving chat messages with tasks/actions. The specific action or actions that are generated at step 804 can be used to access the database 806 and identify one or more priorities associated with the action(s) using the mappings 814. The prioritized processed chat message and action(s) can be provided to at least one user, such as via at least one end-user application 326, which can display the processed chat message and action(s) in a graphical user interface based on the identified priority or priorities.

In this example, feedback 816 may optionally be provided from the end-user application(s) 326 to a machine learning agent 818. The feedback 816 can indicate how well the second machine learning model 324 processed the chat message, identified the action(s), and prioritized the chat message or the action(s). Essentially, from a reinforcement learning perspective, the feedback 816 can represent a reward that may be used by the machine learning agent 818 to update the contents of the database 806. For example, the machine learning agent 818 can use the feedback 816 to identify new actions that can be identified in the mappings 808 or to adjust the priority or priorities of one or more generated actions. These new actions may represent actions for new keywords, additional or replacement actions for previously-existing keywords, or any other suitable actions. Among other things, this may support reinforcement learning or other approaches for updating potential actions based on real-time changes in an environment.

The actions that are identified and prioritized here may include any suitable actions based on the contents of chat messages being processed. In some embodiments, for example, the actions that are identified and prioritized here may include adding symbols or other items on a displayed map or maintaining/updating an item's location on the map. The actions that are identified and prioritized here may also include initiating performance of intelligence, surveillance, and reconnaissance (ISR) operations in order to validate a threat or messaging a tactical system for additional information. The actions that are identified and prioritized here may further include suggestions for using particular assets or optimizing the usage of particular assets in a given environment. In some cases, one or more of the actions may be generated and recommended in an automated manner, such as by using at least one additional machine learning model associated with a smart assistant (likes ones described in U.S. patent application Ser. No. 17/508,450). This may allow the smart assistant to act like a chat participant that interacts with one or more users via chat messages. The smart assistant may also support principle-based decision making when making recommendations to users.

It should be noted that the functions shown in or described with respect to FIGS. 5 through 8 can be implemented in at least one application server 106, end-user device 102a-102d, device 200, or other device(s) in any suitable manner. For example, in some embodiments, at least some of the functions shown in or described with respect to FIGS. 5 through 8 can be implemented or supported using one or more software applications or other software instructions that are executed by one or more processing devices 202. In other embodiments, at least some of the functions shown in or described with respect to FIGS. 5 through 8 can be implemented or supported using dedicated hardware components. In general, the functions shown in or described with respect to FIGS. 5 through 8 can be performed using any suitable hardware or any suitable combination of hardware and software/firmware instructions. Also, the functions shown in or described with respect to FIGS. 5 through 8 can be performed using a single device or any suitable combination of devices.

Although FIGS. 5 through 8 illustrate examples of techniques 500-800 supporting chat message prioritization and reduction, various changes may be made to FIGS. 5 through 8. For example, the second machine learning model 324 may be trained and used in any other suitable manner. Also, while various figures show a series of steps, various steps in these figures may overlap, occur in parallel, occur in a different order, or occur any number of times.

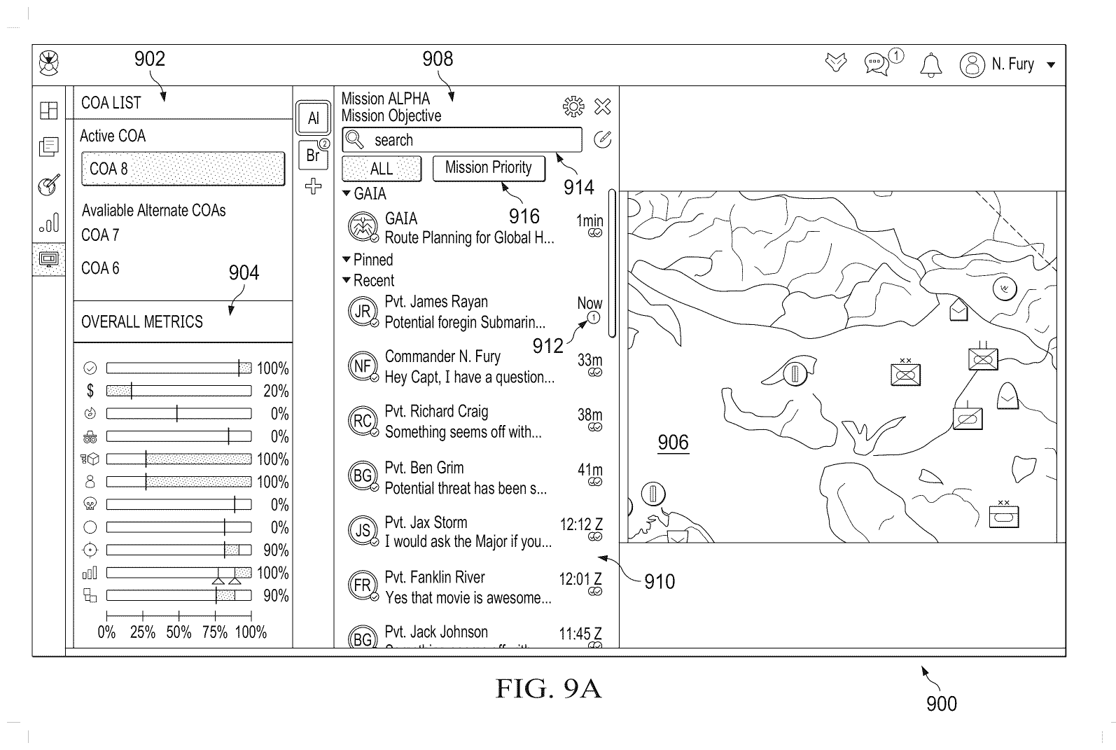

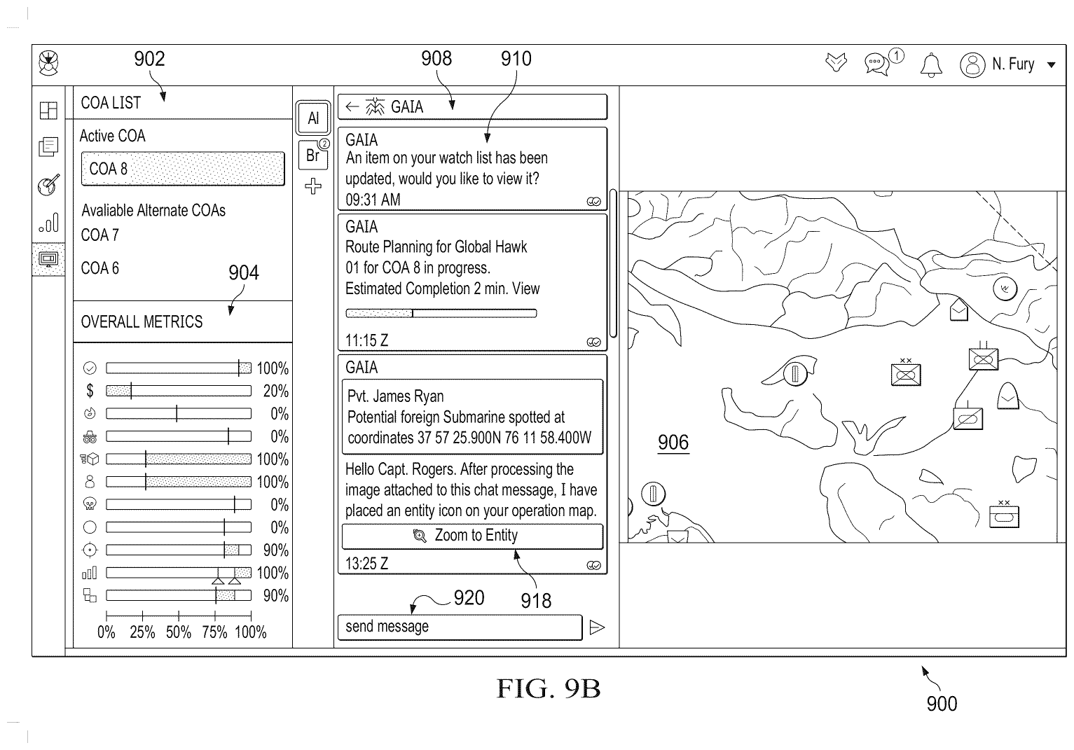

FIGS. 9A and 9B illustrate an example graphical user interface 900 for presenting chat messages according to this disclosure. For example, the graphical user interface 900 may be presented on the display screen of one or more user devices 102a-102d and may include chat messages prioritized and reduced based on the functionality described above. As shown in FIG. 9A, the graphical user interface 900 includes a section 902 that identifies a current course of action (COA) selected by a user and optionally one or more additional courses of action that may be selected by the user. The graphical user interface 900 also includes a section 904 identifying various metrics associated with operations being performed by or associated with the user. The graphical user interface 900 further includes a section 906 containing a map associated with a geographic area in which the user may be monitoring or controlling one or more operations. In some cases, the map may include controls that allow the user to move and zoom in/out as needed or desired. The map may include various symbols that can identify positions of people, equipment, or other assets. In general, these sections 902-906 can include various information, and the contents of these sections 902-906 as shown here are examples only.

In addition, the graphical user interface 900 includes a section 908 displaying chat-related content associated with the user. In this example, the section 908 includes a listing of chat messages 910 involving the user of the graphical user interface 900. The chat messages 910 here can be grouped, such as when the chat messages 910 are grouped based on the other entity with whom the user is communicating. In this example, one of the users is referred to as “GALA,” which refers to a smart assistant named “GAMBIT Artificial Intelligence Assistant.” At least one of the chat messages 910 can have an indicator 912 identifying a higher priority of the chat message(s) 910, where this higher priority can be determined as described above. A search tool 914 may be used to search for chat messages 910 containing certain keywords entered by the user. Controls 916 can be used by the user to control which chat messages 910 are shown in the section 908 of the graphical user interface 900. In this example, the controls 916 can be used to toggle between all chat messages 910 or chat messages 910 having priority.

If a particular chat message 910 (or group of chat messages 910) is selected in the graphical user interface 900, the graphical user interface 900 can be updated to include that particular chat message 910 (or group of chat messages 910) as shown in FIG. 9B. In this example, the selected group of chat messages 910 includes three messages, which have replaced the prior contents of the section 908. As can be seen here, the chat messages 910 in FIG. 9B have been associated with at least one control 918, which may be used to invoke one or more actions identified by the smart assistant (such as is shown in FIG. 8 and described above). In this particular example, a control 918 can be selected to allow the user to zoom to a particular location in the map of the section 906. Another control 920 allows the user to type a chat message in response.

As can be seen here, the graphical user interface 900 can provide a straightforward mechanism with which a user can view chat messages, which can be grouped as needed or desired, and to identify the priorities of the chat messages. Moreover, the user can easily select a particular chat message or group of chat messages for viewing and for invoking one or more actions related to the chat message(s). Among other things, this can help users to achieve improved situational awareness and view the progress of operations being performed in a time-efficient manner, which can be particularly useful for time-critical operations.

Although FIGS. 9A and 9B illustrate one example of a graphical user interface 900 for presenting chat messages, various changes may be made to FIGS. 9A and 9B. For example, the content, layout, and arrangement of the information (including the chat messages) in the graphical user interface 900 of FIGS. 9A and 9B are for illustration only and can vary widely based on the implementation. Also, chat messages that have been corrected, prioritized, and reduced may be used in any other suitable manner.

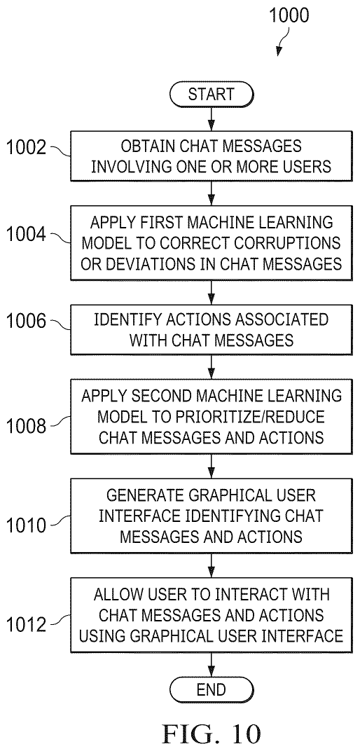

FIG. 10 illustrates an example method 1000 for autonomous chat message correction, prioritization, and reduction according to this disclosure. For ease of explanation, the method 1000 is described as being performed using the application server 106 in order to correct, prioritize, and reduce chat messages involving the user devices 102a-102d, where the application server 106 may be implemented using one or more instances of the device 200. However, the method 1000 may be performed using any other suitable device(s) and in any other suitable system(s).

As shown in FIG. 10, chat messages involving one or more users are obtained at step 1002. This may include, for example, the processing device 202 of the application server 106 obtaining chat messages being sent to, from, or between one or more of the user devices 102a-102d. In some cases, for instance, the chat messages may be sent using an application 112 executing on the application server 106, in which case the application server 106 can obtain the chat messages during normal operation of the application server 106.

A first machine learning model is applied to correct corruptions or deviations contained in one or more of the chat messages at step 1004. This may include, for example, the processing device 202 of the application server 106 applying the first machine learning model 322 in order to correct spelling errors, syntax errors, or other corruptions or deviations contained in one or more of the chat messages. In some cases, the first machine learning model 322 can include multiple pipelines that help to correct the contents of both structured and unstructured chat messages. Actions associated with the chat messages can be identified at step 1006. This may include, for example, the processing device 202 of the application server 106 using the mappings 808 to associate keywords contained in the chat messages with specified actions that can be taken or invoked by one or more users.

A second machine learning model is applied to prioritize the chat messages or actions and optionally to reduce the chat messages at step 1008. This may include, for example, the processing device 202 of the application server 106 applying the second machine learning model 324 in order to identify chat messages or actions that may be more relevant or more important to one or more users. In some cases, the second machine learning model 324 can consider the objective(s) and intent(s) associated with the one or more users when determining how to prioritize the chat messages. Also, in some cases, the second machine learning model 324 can use the mappings 814 to associate priorities of the entities sending/receiving chat messages with tasks/actions. This may further include the processing device 202 of the application server 106 grouping chat messages or preventing certain chat messages from being sent to one or more intended recipients.

The prioritized chat messages and actions may be used in any suitable manner. For instance, in the example shown in FIG. 10, a graphical user interface is generated at step 1010, and the graphical user interface is used to allow one or more users to interact with the chat messages and actions at step 1012. This may include, for example, the processing device 202 of the application server 106 generating a graphical user interface 900 containing at least some of a user's chat messages. Among other things, the graphical user interface 900 may include indicators 912 identifying chat messages that have been determined to have higher priorities. The graphical user interface 900 may also include controls 918 allowing the user to initiate or perform one or more actions associated with the chat messages being displayed.

Although FIG. 10 illustrates one example of a method 1000 for autonomous chat message correction, prioritization, and reduction, various changes may be made to FIG. 10. For example, while shown as a series of steps, various steps in FIG. 10 may overlap, occur in parallel, occur in a different order, or occur any number of times (including zero times). As a particular example, as shown in FIG. 7, the first machine learning model 322 may be invoked selectively to correct corruptions or deviations, such as when a chat message cannot otherwise be processed using the second machine learning model 324. Also, the identification and prioritization of one or more actions is not necessarily required and can be omitted if needed or desired.

Note that while the discussions above have often assumed that chat communications between users are text-based, this is not necessarily required. In other cases, for example, voice recordings can be captured and sent between users. In some embodiments, these voice recordings can be converted from speech into text, and the text can be processed in the same or similar manner described above.

The following describes example embodiments of this disclosure that implement or relate to autonomous chat message correction, prioritization, and reduction. However, other embodiments may be used in accordance with the teachings of this disclosure.

In a first embodiment, a method includes obtaining, using at least one processing device, chat messages being sent to at least one user. The method also includes applying, using the at least one processing device, at least one machine learning model to (i) correct one or more corruptions or deviations contained in at least one of the chat messages and (ii) prioritize the chat messages. The method further includes initiating, using the at least one processing device, display of the prioritized chat messages to the at least one user in a graphical user interface.

In a second embodiment, an apparatus includes at least one processing device configured to obtain chat messages being sent to at least one user. The at least one processing device is also configured to apply at least one machine learning model to (i) correct one or more corruptions or deviations contained in at least one of the chat messages and (ii) prioritize the chat messages. The at least one processing device is further configured to initiate display of the prioritized chat messages to the at least one user in a graphical user interface.

In a third embodiment, a non-transitory computer readable medium contains instructions that when executed cause at least one processor to obtain chat messages being sent to at least one user. The non-transitory computer readable medium also contains instructions that when executed cause the at least one processor to apply at least one machine learning model to (i) correct one or more corruptions or deviations contained in at least one of the chat messages and (ii) prioritize the chat messages. The non-transitory computer readable medium further contains instructions that when executed cause the at least one processor to initiate display of the prioritized chat messages to the at least one user in a graphical user interface.

Any single one or any suitable combination of the following features may be used with the first, second, or third embodiment. The at least one machine learning model may include (i) a first machine learning model trained to correct the one or more corruptions or deviations contained in the at least one chat message and (ii) a second machine learning model trained to prioritize the chat messages. The first machine learning model may be trained using supervised learning, and the second machine learning model may be trained using reinforcement learning. The second machine learning model may be trained to autonomously prioritize the chat messages and reduce a quantity of the chat messages provided to the at least one user based on at least one objective or intent associated with the at least one user. The second machine learning model may be further trained to identify one or more recommended actions associated with one or more of the chat messages, and the graphical user interface may include one or more controls associated with the one or more recommended actions. The first machine learning model may include multiple pipelines, a first of the pipelines may be configured to process chat messages containing unstructured language contents, and a second of the pipelines may be configured to process chat messages containing structured contents. The graphical user interface may include a map showing a geographic area associated with one or more operations being monitored or controlled by the at least one user, and the at least one machine learning model may be configured to prioritize one or more chat messages associated with the geographic area above one or more chat messages associated with other geographic areas.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining, using at least one processing device, chat messages being sent to at least one user;
applying, using the at least one processing device, at least one machine learning model to (i) correct one or more corruptions or deviations contained in at least one of the chat messages and (ii) prioritize the chat messages; and
initiating, using the at least one processing device, display of the prioritized chat messages to the at least one user in a graphical user interface.

2. The method of claim 1, wherein the at least one machine learning model comprises:
a first machine learning model trained to correct the one or more corruptions or deviations contained in the at least one chat message; and
a second machine learning model trained to prioritize the chat messages.

3. The method of claim 2, wherein:
the first machine learning model is trained using supervised learning; and
the second machine learning model is trained using reinforcement learning.

4. The method of claim 2, wherein the second machine learning model is trained to autonomously prioritize the chat messages and reduce a quantity of the chat messages provided to the at least one user based on at least one objective or intent associated with the at least one user.

5. The method of claim 2, wherein:
the second machine learning model is further trained to identify one or more recommended actions associated with one or more of the chat messages; and
the graphical user interface includes one or more controls associated with the one or more recommended actions.

6. The method of claim 2, wherein the first machine learning model comprises multiple pipelines, a first of the pipelines configured to process chat messages containing unstructured language contents, a second of the pipelines configured to process chat messages containing structured contents.

7. The method of claim 1, wherein:
the graphical user interface comprises a map showing a geographic area associated with one or more operations being monitored or controlled by the at least one user; and
the at least one machine learning model prioritizes one or more chat messages associated with the geographic area above one or more chat messages associated with other geographic areas.

8. An apparatus comprising:
at least one processing device configured to:
obtain chat messages being sent to at least one user;
apply at least one machine learning model to (i) correct one or more corruptions or deviations contained in at least one of the chat messages and (ii) prioritize the chat messages; and
initiate display of the prioritized chat messages to the at least one user in a graphical user interface.

9. The apparatus of claim 8, wherein the at least one machine learning model comprises:
a first machine learning model trained to correct the one or more corruptions or deviations contained in the at least one chat message; and
a second machine learning model trained to prioritize the chat messages.

10. The apparatus of claim 9, wherein:
the first machine learning model is trained using supervised learning; and
the second machine learning model is trained using reinforcement learning.

11. The apparatus of claim 9, wherein the second machine learning model is trained to autonomously prioritize the chat messages and reduce a quantity of the chat messages provided to the at least one user based on at least one objective or intent associated with the at least one user.

12. The apparatus of claim 9, wherein:
the second machine learning model is further trained to identify one or more recommended actions associated with one or more of the chat messages; and
the graphical user interface includes one or more controls associated with the one or more recommended actions.

13. The apparatus of claim 9, wherein the first machine learning model comprises multiple pipelines, a first of the pipelines configured to process chat messages containing unstructured language contents, a second of the pipelines configured to process chat messages containing structured contents.

14. The apparatus of claim 8, wherein:
the graphical user interface comprises a map showing a geographic area associated with one or more operations being monitored or controlled by the at least one user; and
the at least one machine learning model is configured to prioritize one or more chat messages associated with the geographic area above one or more chat messages associated with other geographic areas.

15. A non-transitory computer readable medium containing instructions that when executed cause at least one processor to:
obtain chat messages being sent to at least one user;
apply at least one machine learning model to (i) correct one or more corruptions or deviations contained in at least one of the chat messages and (ii) prioritize the chat messages; and
initiate display of the prioritized chat messages to the at least one user in a graphical user interface.

16. The non-transitory computer readable medium of claim 15, wherein the at least one machine learning model comprises:
a first machine learning model trained to correct the one or more corruptions or deviations contained in the at least one chat message; and
a second machine learning model trained to prioritize the chat messages.

17. The non-transitory computer readable medium of claim 16, wherein the second machine learning model is trained to autonomously prioritize the chat messages and reduce a quantity of the chat messages provided to the at least one user based on at least one objective or intent associated with the at least one user.

18. The non-transitory computer readable medium of claim 16, wherein:
the second machine learning model is further trained to identify one or more recommended actions associated with one or more of the chat messages; and
the graphical user interface includes one or more controls associated with the one or more recommended actions.

19. The non-transitory computer readable medium of claim 16, wherein the first machine learning model comprises multiple pipelines, a first of the pipelines configured to process chat messages containing unstructured language contents, a second of the pipelines configured to process chat messages containing structured contents.

20. The non-transitory computer readable medium of claim 15, wherein:
the graphical user interface comprises a map showing a geographic area associated with one or more operations being monitored or controlled by the at least one user; and
the at least one machine learning model is configured to prioritize one or more chat messages associated with the geographic area above one or more chat messages associated with other geographic areas.
